(19) United States
(12) Patent Application Publication
(10) Pub. No.: US 2014/0090075 A1
(43) Pub. Date: Mar. 27, 2014

(54) FLEXIBLE CONTENT PROTECTION SYSTEM USING DOWNLOADABLE DRM MODULE

(71) Applicant: SAMSUNG ELECTRONICS CO., LTD., Suwon City (KR)

(72) Inventors: Sanjeev VERMA, San Jose, CA (US); Onur ACIICMEZ, Santa Clara, CA (US); Byung-Rae LEE, Seoul (KR)

(73) Assignee: SAMSUNG ELECTRONICS CO., LTD., Suwon City (KR)

(21) Appl. No.: 13/627,770

(22) Filed: Sep. 26, 2012

(51) Int. Cl. G06F 21/00

(52) U.S. Cl. 726/26

(57) ABSTRACT

A secure platform is enabled in which DRM modules can be downloaded and securely installed onto a consumer electronic device, such as a TV. Downloadable DRM solutions are supported for CE manufacturers. The problem of making downloadable DRM modules operate securely on a trusted generic hardware platform without compromising the security of DRM systems is addressed. The downloadable DRM solution uses secure trusted computing-based mechanisms thereby enabling a service provider to perform remote static and dynamic (run-time) attestation of the downloaded DRM module and DRM license in the media device and of content protection application (CPA).

### TECHNICAL FIELD

The present invention relates generally to content protection software and media playing devices. More specifically, it relates to downloading content protection software and licenses onto devices in a secure manner.

### BACKGROUND OF THE INVENTION

There are currently a number of ways used to protect against the free use and transfer of high-value digital content. This type of content protection is often referred to as Digital Rights Management (DRM). This is used by content providers to protect their high-value media content, such as high-definition, feature-length movies and TV shows.

DRM systems protect and ensure controlled consumption and distribution of digital content throughout the life cycle of the content. As such, DRM systems often have strict security requirements which are critical to their effectiveness and reliability. There are a number of DRM systems available. This has led to implementation of a number of DRM systems and also to a dilemma for the highly competitive and price-driven consumer electronics (CE) market. It is costly to support multiple DRM solutions for a single CE device. The other option for CE device manufacturers is to provide custom solutions for every service provider and market. This is also very costly. From the user's perspective, the consumer would like to buy one device (e.g., a TV) and use one or more service providers (who provide content) of his choice.

One option is to push the problem to the service provider by making them support multiple DRM systems. Another option is to push the problem to the CE device manufacturer by making them support the new concept of downloadable DRM solutions on trusted generic hardware. The second approach is preferable since any security breach can be fixed by updating the DRM software. However, this approach is not easy to implement since the security requirements of DRM systems are very stringent and, as noted, are critical to its effectiveness and reliability. Content producers must be confident that DRM systems are installed and execute securely.

### SUMMARY OF THE INVENTION

Methods and systems for enabling a secure platform where DRM modules can be downloaded and securely installed are described. Embodiments support downloadable DRM solutions for CE manufacturers and address the problem of making downloadable DRM modules operate securely on a trusted generic hardware platform without compromising the security of DRM systems. The downloadable DRM solution uses secure trusted computing-based mechanisms thereby enabling a service provider to perform remote static and dynamic (run-time) attestation of the downloaded DRM module and DRM license in the media device and of content protection application (CPA).

Various embodiments provide ways in which a service provider does not need to support more than one DRM system and the CE device can download a content protection module supported by the service provider. A device manufacturer does not need to support multiple DRM systems to address the needs of various providers and markets. It also simplifies responsibilities for the service provider since in the case of a multi-DRM solution they would also need to support multiple license servers. Various embodiments provide a secure trusted platform on the media player, such as the TV or STB, which is more versatile and cost-efficient than having only one DRM or even an ecosystem of DRMs (e.g., 4 or 5 DRM systems) on the device.

In various embodiments, processes of downloading a DRM module or, more generally, a content protection module, involve three phases: a content purchase phase, a content protection system download phase (also referred herein to as “DRM module download phase”), and a license acquisition phase.

### BRIEF DESCRIPTION OF THE DRAWINGS

The invention and the advantages thereof may best be understood by reference to the following description taken in conjunction with the accompanying drawings in which:

FIG. 1 is a block diagram of the various components and entities involved in implementing these three phases in various embodiments of the present invention;

FIG. 2 is a block diagram of showing details of media player and service provider applications server and the data exchanged between the two components in accordance with various embodiments;

FIG. 3 is a block diagram showing DRM download server and exchanges with media player in accordance with various embodiments;

FIG. 4 is a block diagram showing a license server in communication with media player in accordance with various embodiments;

FIG. 5 is as flow diagram of a process of requesting content and obtaining the DRM module and a license for the content for playback on the media player in accordance with various embodiments;

FIG. 6 is a flow diagram of a process of transmitting a DRM module to a media player from a DRM download server in accordance with various embodiments;

FIG. 7 is a block diagram showing components and data exchange for a dynamic run-time check of the downloaded DRM module in accordance with various embodiments;

FIG. 8 is a block diagram of components needed in performing runtime integrity checks of the downloaded licenses in accordance with various embodiments; and

FIGS. 9A and 9B are diagrams of a computing device suitable for implementing embodiments of the present invention.

In the drawings, like reference numerals are sometimes used to designate like structural elements. It should also be appreciated that the depictions in the figures are diagrammatic and not to scale.

### DETAILED DESCRIPTION OF THE INVENTION

Methods and systems for enabling a secure platform where DRM modules can be downloaded and securely installed. Embodiments of the present invention support downloadable DRM solutions for CE manufacturers. As described in greater detail below, trusted computing concepts and ARM's TrustZone technology, are used to remotely attest the platform (on the devices) and other components. Various embodiments address the problem of making downloadable DRM modules operate securely on a trusted generic hardware platform without compromising the security of DRM systems. The downloadable DRM solution of the present invention uses secure trusted computing-based mechanisms thereby enabling a service provider to perform remote static and dynamic (run-time) attestation of the downloaded DRM module and DRM license in the media device and of content protection application (CPA).

Various embodiments of the present invention provide ways in which a service provider does not need to support more than one DRM system and the CE device can download a content protection module supported by the service provider. With the present invention, a device manufacturer does not need to support multiple DRM systems to address the needs of various providers and markets. It also simplifies responsibilities for the service provider since in the case of a multi-DRM solution they would also need to support multiple License servers. The present invention provides a secure trusted platform on the media player, such as the TV or STB, that is more versatile and cost-efficient than having only one DRM or even an ecosystem of DRMs (e.g., 4 or 5 DRM systems) on the device.

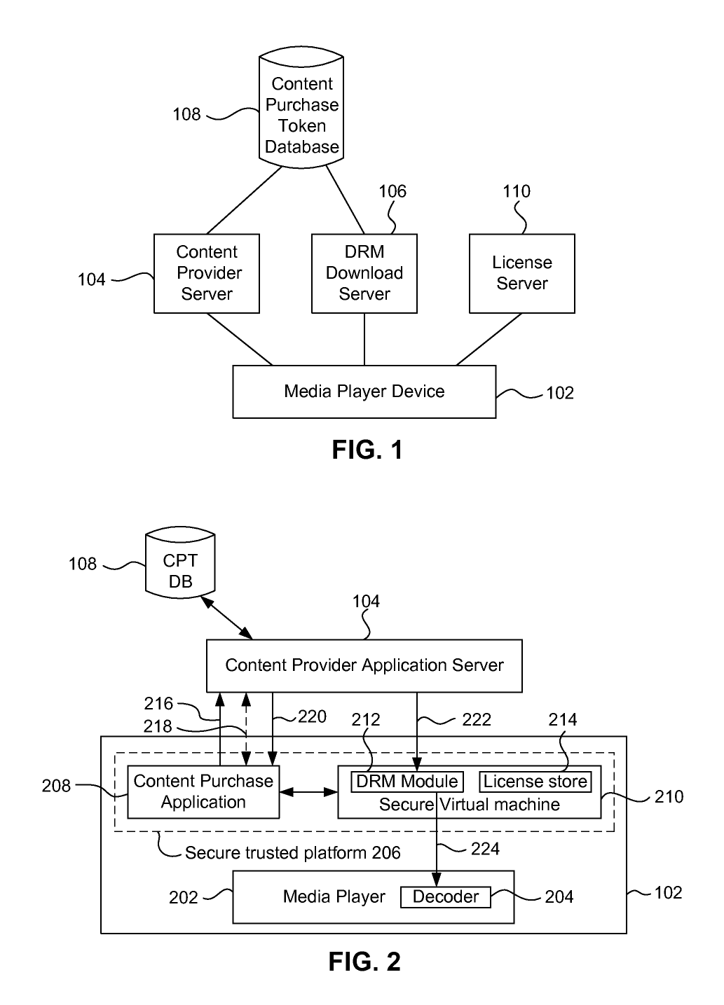

In various embodiments, processes of downloading a DRM module or, more generally, a content protection module, involve three phases: a content purchase phase, a content protection system download phase (also referred herein to as “DRM module download phase”), and a license acquisition phase. FIG. 1 is a block diagram of the various components and entities involved in implementing these three phases in various embodiments of the present invention. A media player 102, such as a DVD player, an STB, a tablet, PC, or smart phone, is in communication with three servers. This communication is typically performed over the Internet but may be done over a private network within an enterprise. Internal components and modules of media player 102 are described in FIG. 2.

In one embodiment, media player 102 is connected to three servers. Although the servers are shown as separate components in FIG. 1, two or more of them may reside and execute on the same physical computing device (i.e., on the same server computer). A database is also shown as a separate component, however, depending on how the system is implemented, the database may reside on one or more of the servers or may be distributed among two or more servers. One of the components is a service provider applications server 104. This server provides or streams the content to media player 102 upon receiving payment. The content may be streamed or downloaded from service provider applications server 104 to media player 102.

Media player 102 is also in communication with DRM download server 106. This server authenticates media player 102 and provides the player with the DRM module and CSP policy and performs related functions. As noted above, servers 104 and 106 may be on separate hardware computing devices or may execute on the same server computer. Each of the servers 104 and 106 is in communication with a content purchase token (CPT) database 108. This database may be maintained by the service (content) provider and allows the service provider to keep track of whether a user has paid for a particular content. As such, media player 102 does not need to store this information. In one embodiment, database 108 may be stored on the Internet or in the cloud. A CPT functions as a proof of purchase and is sent to media player 102 in an initialization segment (e.g., in “pssh” box in “moov” header of MP4 file).

Media player 102 is also connected to a license server 110 which performs remote attestation of the downloaded DRM module and provides the DRM-specific license for media player 102 (to play the content) using a DRM-specific license acquisition protocol. This and other attestations and exchanges of data are described in greater detail in the figures below.

Not shown in FIG. 1 is an impartial trust management (ITM) entity that is trusted by the various DRM vendors. The ITM is the party that performs the various attestations of the software at particular phases as described below. It ensures the compliance and robustness of the DRM module download procedure. It also issues certificates to media playing devices.

FIG. 2 is a block diagram of showing details of media player 102 and service provider applications server 104 and the data exchanged between the two components in accordance with various embodiments. Also shown is CPT database 108 connected to server 104. Media player 102 contains hardware and other components for playing media shown generically in box 202, including a decoder 204. Embodiments of the present invention are not directly related to media player hardware 202 or decoder 204 and, therefore, these components are not described in detail herein.

Media player 102 has a secure trusted platform 206 which contains modules that exchange data and performs most of the functions needed for providing a secure environment for a downloadable DRM implementation. In one embodiment, platform 206 contains a content purchase application 208 and a secure virtual machine 210. Virtual machine 210 contains a DRM module 212 and a license store 214. Each of these is described in more detail below.

In one embodiment, content purchase application 208 has certain exchanges with server 104 indicated by arrows 216, 218, and 220. Arrow 216 represents a request for content from the user of media player 102 to service provider application server 104 (operated by the service provider). Presumably, this may be done after the user has browsed the content and decided on a selection. Arrow 218 represents two-way interaction resulting in payment for the requested content. The dashed lines indicate that in some embodiments, payment may not be necessary at the time the content is requested (i.e., some content may be free) or may be optional. Arrow 220 represents transmission of an initialization header from server 104 to content purchase application 208.

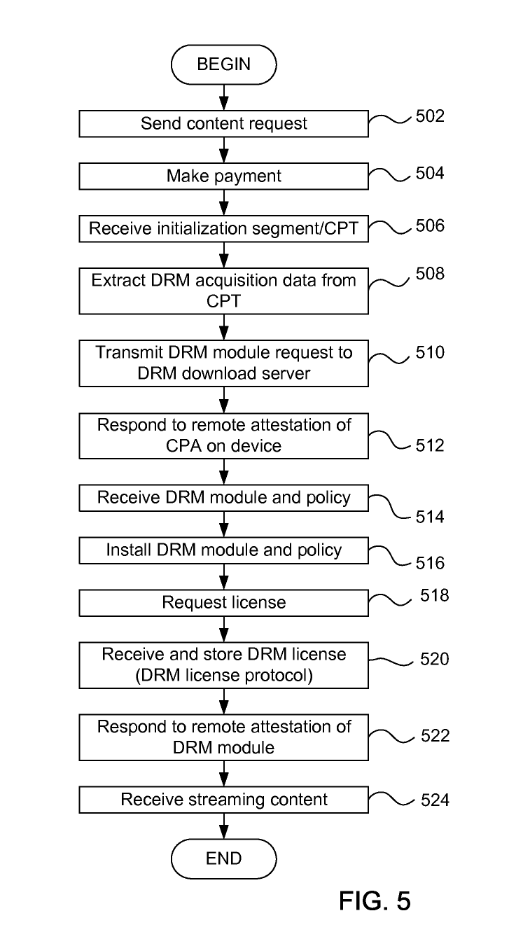

In one embodiment, a CPT (proof of purchase) is sent to CPA 208 in this initialization header or segment. This segment may also carry other metadata, such as supported content protection mechanisms relating to the requested content, especially in cases where the service provider supports more than one content protection mechanism. It essentially provides information on how the content is protected (i.e., by which DRM system). At this stage, after transmission of the initialization header, CPA 208 verifies the CPT and obtains relevant information needed to initiate acquisition of the DRM module and license. The service provider also updates CPT database 108. Details of this step and the encompassing process from requesting content to receiving the content is described in FIG. 5. The last arrow in FIG. 2, arrow 222, represents content being streamed or downloaded from server 104 to DRM module 212 from where it is transmitted to decoder 204.

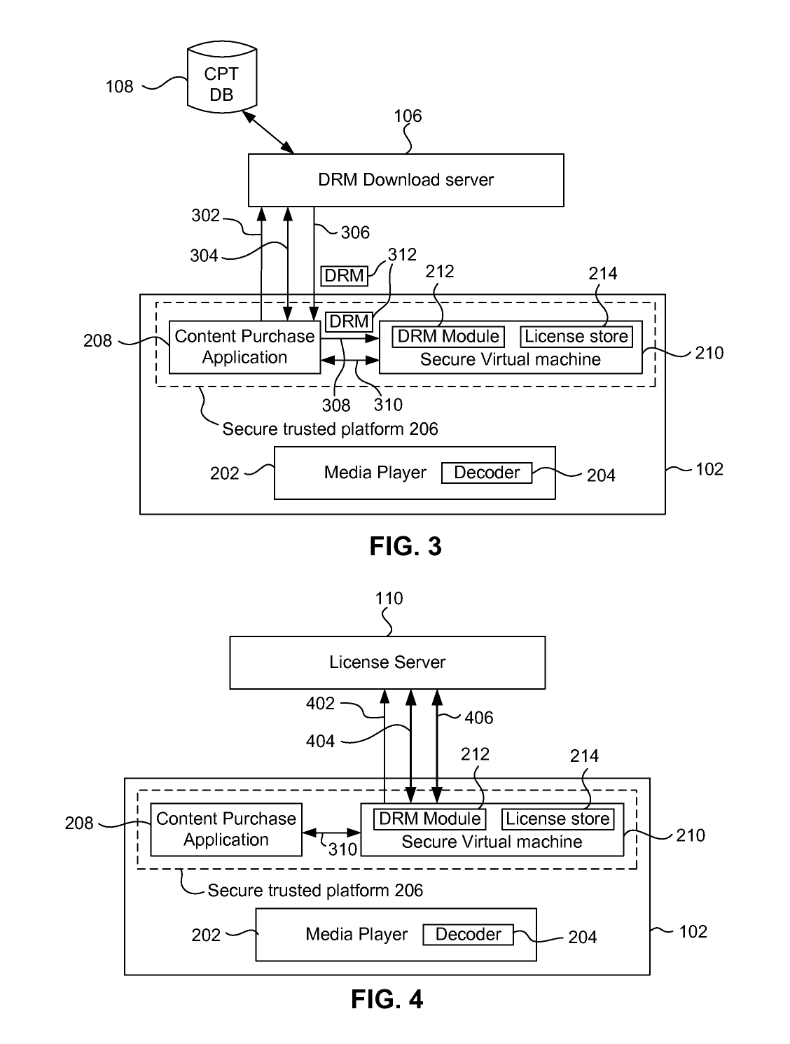

FIG. 3 is a block diagram showing DRM download server 106 and exchanges with media player 102 in accordance with various embodiments. Components of media player 102 are the same as those shown in FIG. 2. DRM download server 106 has a series of communications with media player 102, specifically with CPA 208. Also shown in FIG. 3 are communications between CPA 208 and secure virtual machine 210.

Communications indicated by arrows 302, 304, and 306 take place after exchanges between CPA 208 and server 104 (arrows 216, 218, and 220). Arrow 302 represents a request for a DRM module or, more generally, a content protection module, from CPA 208 to server 106. Server 106 responds by performing a remote authentication or attestation of media player 102 and also of CPA 208. As described below, DRM server 106 will not download a DRM module 312 to any device or application without first authenticating both entities. As noted above, this can be done using trusted computing-based tools. Assuming media player 102 and CPA 208 are authenticated, arrow 306 represents the downloading of a DRM module 312 and CSP policy from server 106 to CPA 208. In other embodiments, only one of the two entities (player 102 or CPA 206) is authenticated. In other embodiments, the CSP policy may be downloaded at a different time or in a separate transmission immediately after or before the DRM module is downloaded.

Once DRM module 312 is downloaded to CPA 208, it is securely installed in DRM module 212 over a trusted interface between CPA 208 and secure virtual machine 210. This trusted interface is shown by arrow 310. DRM module 312 is transmitted over trusted interface 310 and installed as DRM module 312. It is useful to note here that trusted interface 310, as well as the attestations performed by DRM server 106 of player 102 and CPA 208, are steps taken to adhere to the strict security requirements of DRM systems as noted above. Other steps are also taken as described in the figures below.

FIG. 4 is a block diagram showing a license server 110 in communication with media player 102 in accordance with various embodiments. It is similar to FIGS. 2 and 3. In one embodiment there are three exchanges between server 110 and player 102, specifically secure virtual machine 210. These exchanges occur after DRM module 312 has been downloaded and installed on secure virtual machine 210. As is known in the art, the content cannot be played (i.e., streamed) on player 102 unless there is a license for the content. Arrow 402 represents a request from virtual machine 210 or other suitable component in player 102 for a license to play the content. However, as described below, server 110 enables a license on player 102, it takes certain precautions to ensure that all components and modules are attested and/or authenticated, in keeping with the strict security requirements of DRM systems.

Arrow 404 represents a remote attestation of the downloaded DRM module by license server 110. Server 110 ensures that the DRM module that resides on player 102 for is authentic. It will not send a license to play the content unless the content protection mechanisms on the player are validated. As noted above, this software attestation of the downloaded DRM module may be performed using trusted computing tools and concepts. Once DRM module 312 passes the attestation challenge, server 110 uses a DRM-specific authentication protocol to download the license for the content to player 102. This is shown by arrow 406. This is typically the last interaction needed with license server 110.

Once the license or license token has been issued, content may be streamed to player 102. This is shown in FIG. 2 by arrows 222 and 224. Arrow 222 represents streaming content (or downloading content, such as a TV show or a movie) from service provider applications server 104 to media device player 102, specifically to DRM module 312, as is conventionally done. From there the content is transmitted to decoder 204.

FIG. 5 is as flow diagram of a process of requesting content and obtaining the DRM module and a license for the content for playback on the media player in accordance with various embodiments. Before the first step, a user desiring to play some content via a media player (e.g., a DVD player or PC), may browse content on a service provider Web site or on a TV menu and select a particular content, such as a movie or TV show. Once the user has decided which content to view, she selects the title on the playback device, such as smart phone, tablet, or computer. At step 502 a content request message is sent from the media player, specifically from the content purchase application, to a service provider server (server 104). At step 504 payment is made or the user agrees to pay a fee for the content (which may appear in a monthly bill). In some cases payment may not be necessary because the content is free or part of a subscription. If payment is needed, it may be done using presently known processes. At step 506, the media player receives an initialization segment. This initialization segment contains a content purchase token (CPT) which functions as proof of purchase. These CPTs are stored in CPT database 108 maintained at the service provider. In one embodiment, the initialization segment may also contain metadata relating to the requested content and other data that may be useful in cases where the service provider supports more than one content protection mechanism.

At step 508 the CPA verifies the CPT to ensure that it is authentic and extracts or obtains DRM acquisition data from the CPT. This verification of the CPT need not be an attestation of the CPT. The data extracted from the CPT is needed to acquire the DRM module and the license. The CPA or other module in the media player may check whether the required DRM is already on the media player before proceeding with the DRM module download process. During this step or previous to this step, the service provider updates the CPT database.

If the media player does not already have the DRM module, at step 510 the CPA transmits a DRM module request or, more generally, a request for a content protection mechanism module, to the DRM download server (server 106). This request may contain the user's AccountID with the service provider and a ContentID. It may also contain a DRM system identifier in case more than one DRM system is supported by the service provider. The DRM server checks that the user AccountID is valid and, if needed, that the content has been paid for. It may do this by sending a query message to the CPT database.

The DRM server also ensures that the request is from a valid media device and content protection application. In one embodiment, it uses trusted computing based technologies to ensure that the application has not been tampered with. That is, the DRM server performs a remote attestation of the CPA on the media device. This is shown in step 512 in which the CPA responds to a remote attestation challenge from the DRM server. This is to authenticate the media player device (e.g., to ensure that it is not a clone device) and to ensure that the CPA making the request has not been tampered with and is authorized. The remote attestation checks the media player device certificate issued by the ITM and makes sure it is valid and has a signature of the ITM and the service provider. The CPA is checked using remote software attestation, again, using trusted computing based technologies. This is to ensure that the CPA is also valid and does not contain malware.

At step 514 the media device receives the DRM module and CSP policy. A policy can be used by a DRM vendor to monitor the DRM module during runtime. The DRM policy can be in the form of a virtual machine. More specifically, the CPA downloads the DRM module and securely installs it in the secure virtual machine over the trusted interface 310. This is shown in step 516. Trusted computing based technology is used in order to check the integrity of the software stack running the DRM module. The secure virtual machine also provides secure storage, referred to as license store 214 for storing the DRM licenses (described below).

At step 518 the downloaded DRM module requests a license to play the requested content. The request sent to a license server may contain the ContentID. The license acquisition phase is triggered either by the DRM license server (e.g., ROAP trigger for OMA DRM) or when the media player checks the CPT database and intends to acquire and play the content for which payment has already been made. In one embodiment, the media player has already downloaded the DRM protected content and wants to acquire the license to render the content. In another embodiment, the protected content is streamed to the media player.

At step 520 the DRM module responds to a remote software attestation by the license server to ensure that the license request is coming from a valid DRM module before downloading the license. As noted above, the license server can use trusted computing technology to verify that the DRM module has not been tampered with and is running on a valid software stack. Once the license server determines that the request is coming from a valid DRM module a DRM-specific authentication protocol is used to download the license to the media player. Assuming the DRM module is able to successfully perform the remote software attestation, the license is transmitted to the media player and stored in a license store in the secure virtual machine at step 522. In one embodiment, the service provider performs a run-time check in the platform of all licenses that are downloaded by the DRM module. This may be done by keeping a checksum of all licenses. This also enables an integrity check of all downloaded licenses. This static check ensures that runtime behavior of the DRM module is proper and valid. This is to ensure that the licenses that are downloaded are not manipulated. At step 524 the media player receives the downloaded content (if it was not downloaded previously) or receives the content via streaming. The content goes to the DRM module which then transmits it to the decoder in the media player hardware.

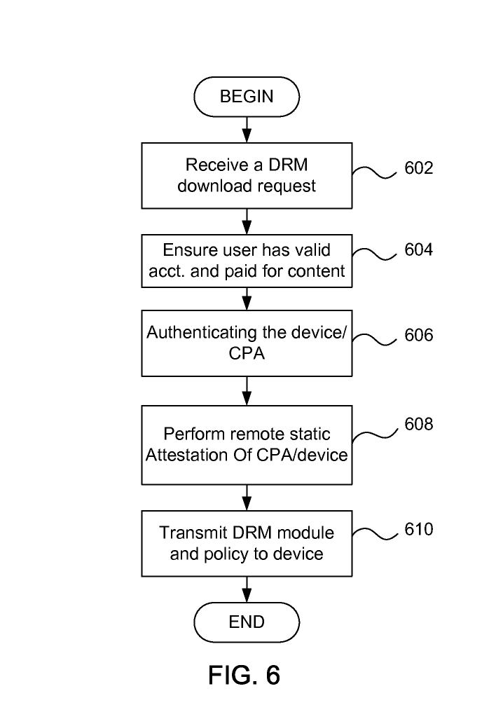

FIG. 6 is a flow diagram of a process of transmitting a DRM module to a media player from a DRM download server in accordance with various embodiments. The steps in FIG. 6 are from the perspective of the DRM download server and describe many of the steps described in FIG. 5 but from a different vantage point. As noted above, there are a number of different DRM systems that are commercially available and being used. The DRM download server described here is operated and maintained by one DRM provider. In other embodiments, it is possible that the DRM download server is able to provide downloads for DRM modules from different DRM systems. At step 602 the download server receives a DRM module download request from a media player. This request is transmitted over the Internet and is typically sent from a CPA or similar application on the media player.

In one embodiment, at step 604, the DRM download module ensures that the user of the media player device has a valid user account (valid AccountID) and has paid for the content, if needed. This is done by checking the CPT database which, although maintained by the service provider, the DRM download server has access to. The request to download the DRM module from the device contains the user's AccountID and ContentID. It may also contain a DRM system identifier if there is more than one DRM system supported by the service provider.

At step 606 the DRM download server proceeds to verify the media player device. In order to authenticate the actual media playing device, the server checks that the device certificate issued by an impartial trust management (ITM) entity, trusted by the DRM system vendors, and that the certificate is signed by the ITM and the service provider (the entity providing the licensed content). In other embodiments, other means for verifying the media player may be used, however, such means will likely include the role of the ITM. At step 608, the download server checks the CPA software. Using trusted computing based technology, the download server ensures that the CPA is valid using remote software attestation. The device verification and CPA authentication may take place at the same time by the DRM download server or in a different order. At step 610 the DRM download server transmits the DRM module and policy to the media playing device. The policy may be used to monitor the DRM module during runtime.

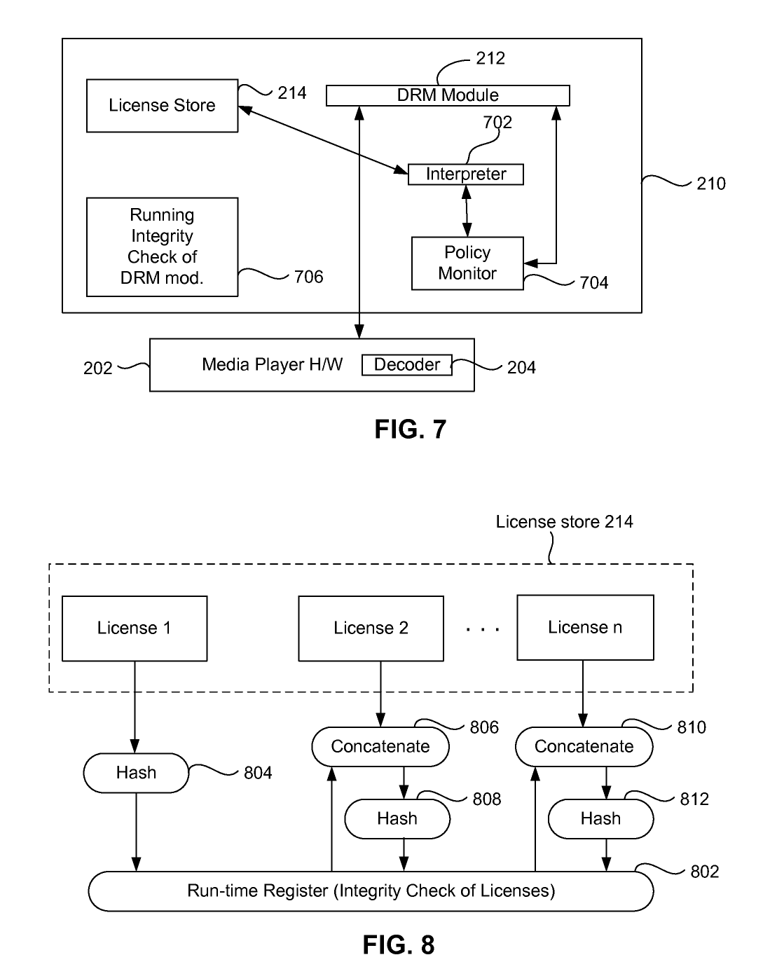

FIG. 7 is a block diagram showing components and data exchange for a dynamic run-time check of the downloaded DRM module in accordance with various embodiments. As noted above, a DRM policy may be provided by the DRM vendor to monitor the downloaded module during runtime. The components in FIG. 7 allow for a mechanism to do a run-time attestation of the downloaded module by the service provider. In one embodiment, the DRM vendor may provide its security policy which can be implemented using an interpreter (e.g., implemented in byte code) that enforces proper run-time behavior by trapping all the actions of the downloaded DRM module (which may also be referred to as DRM agent).

Shown is secure virtual machine 210 which has license store 214 and DRM module 212, as described above. DRM module 212 transmits content to media player hardware 202, specifically to decoder 204, as is conventionally done. However, to provide additional security for the DRM and the protected content, an interpreter 702 interacts with a policy or policy monitor 704, provided by the service provider. Policy monitor 704 (which is the CSP policy described above) interacts with and captures events by DRM module 212. Thus, policy monitor 704 watches DRM module 212 and sends data to interpreter 702. It is also in communication with a module 706 that performs a running integrity check of the DRM module. Thus, the actual check on DRM module 212 is done at module 706 with the assistance of interpreter 702 and policy monitor 704.

In another embodiment, a sandboxing principle may be used to monitor any improper behavior of the DRM module or agent. For example, the DRM agent is not allowed to interact with anything other than license store 214 and media player hardware 202. In another embodiment, behavioral analysis can also be used to interpret the correct run-time behavior of the downloaded DRM module.

As noted, embodiments of the present invention allow for downloading DRM modules based on the content that is purchased so that the media player device does not have to have the DRM system resident on the player device. However, DRM systems have strict security requirements. DRM systems must execute on a secure platform where the DRM module can be downloaded and securely installed and executed. This may be necessary in order for the service (content) provider to fully trust and rely on the concept of downloading DRM modules on an ‘as needed’ basis onto media player devices.

One threat to the security of the DRM download mechanism and content playback is the potential modification of the licenses stored in media player device 102. Embodiments of the present invention implement a runtime register for integrity checking of the downloaded licenses. For example, this can be a Platform Configuration Register if trusted computing-based technology is used. The integrity of the downloaded licenses may be checked by the license server. In one embodiment, license server 110 sends a request to media device 102 to send an integrity check of the downloaded licenses. License server 110 keeps track of all licenses receives or downloaded by a particular media playing device. If the number of licenses downloaded by the server does not match the integrity check value or number sent to server 110 from the device, the integrity check fails and the license server may refuse to honor new license requests. In another embodiment, the media device checks the integrity of the stored licenses in the license storage against the runtime stored value in the runtime register.

FIG. 8 is a block diagram of components needed in performing runtime integrity checks of the downloaded licenses in accordance with various embodiments. License store 214 contains n number of licenses for various contents on a device. Also shown is a runtime register 802 that is on the device. For example, it may be in secure virtual machine 210. A license 1 is hashed and a hash value 804 is created and stored in runtime register 802. A license 2 is hashed and concatenated 806 with hash value 804 to create hash value 808 which is stored in register 802. This process continues to license n being hashed and concatenated with hash value 808 to create hash value 812.

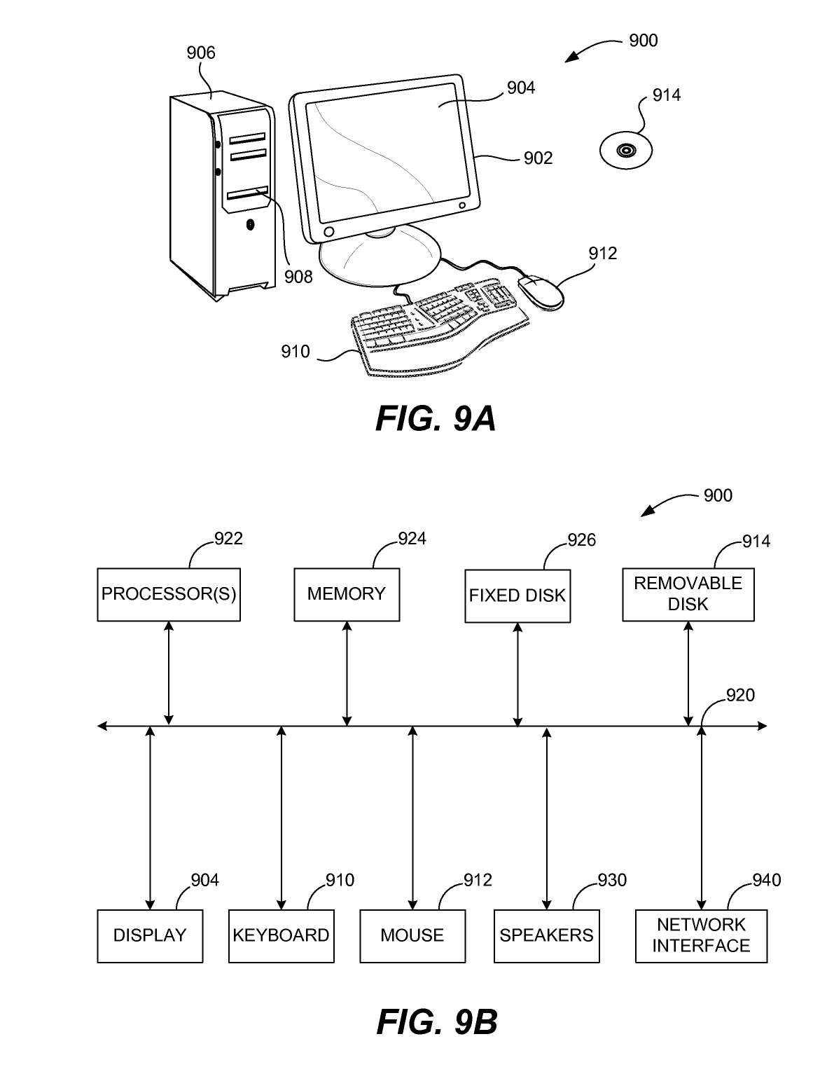

As noted above, the various computing devices (servers and media playing device) may be, for example, a TV, an STB, a smart phone, a tablet computer, a mobile device, a PC or laptop computer, or other suitable device. FIGS. 9A and 9B illustrate a generic computing system 900 suitable for implementing specific embodiments of the present invention. Some of the devices that can be used in the present invention may have other features or components that are not shown in FIGS. 9A and 9B and not all the components shown in these figures (e.g., the keyboard) are needed in the offsite or onsite devices for implementing the present invention. As such, FIG. 9A shows one possible physical implementation of a computing system. In one embodiment, system 900 includes a display or screen 904. This display may be in the same housing as system 900. It may also have a keyboard 910 that is shown on display 904 (i.e., a virtual keyboard) or may be a physical component that is part of the device housing. It may have various ports such as HDMI or USB ports (not shown). Computer-readable media that may be coupled to device 900 may include USB memory devices and various types of memory chips, sticks, and cards.

FIG. 9B is an example of a block diagram for computing system 900. Attached to system bus 920 is a variety of subsystems. Processor(s) 922 are coupled to storage devices including memory 924. Memory 924 may include random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 926 is also coupled bi-directionally to processor 922; it provides additional data storage capacity and may also include any of the computer-readable media described below. Fixed disk 926 may be used to store programs, data and the like and is typically a secondary storage medium that is slower than primary storage. It will be appreciated that the information retained within fixed disk 926, may, in appropriate cases, be incorporated in standard fashion as virtual memory in memory 924.

Processor 922 is also coupled to a variety of input/output devices such as display 904 and network interface 940. In general, an input/output device may be any of: video displays, keyboards, microphones, touch-sensitive displays, tablets, styluses, voice or handwriting recognizers, biometrics readers, or other devices. Processor 922 optionally may be coupled to another computer or telecommunications network using network interface 940. With such a network interface, it is contemplated that the CPU might receive information from the network, or might output information to the network in the course of performing the above-described method steps. Furthermore, method embodiments of the present invention may execute solely upon processor 922 or may execute over a network such as the Internet in conjunction with a remote processor that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are illustrative and not restrictive, and the invention is not to be limited to the details given herein, but may be modified within the scope and equivalents of the appended claims.

What we claim is:

1. A method of playing content on a media playing device, the method comprising:
receiving a content purchase receipt in response to a request to purchase content;
transmitting a DRM request for a DRM module to a DRM download server;
responding to a first remote attestation of a content provider application on the media playing device;
receiving the DRM module;
installing the DRM module in a secure virtual machine on the media playing device;
responding to a license integrity check by a license server; and
receiving the content.

2. A method as recited in claim 1 further comprising:
transmitting a content request for a content to a content provider.

3. A method as recited in claim 1 further comprising:
extracting DRM acquisition data from the content purchase receipt needed for acquiring a DRM module and a content license.

4. A method as recited in claim 1 wherein said first remote attestation is performed by the DRM download server.

5. A method as recited in claim 1 wherein installing the DRM module in a secure virtual machine further comprises:
utilizing a secure interface between the content purchase application and the secure virtual machine.

6. A method as recited in claim 1 further comprising:
securely storing a DRM license received from a license server.

7. A method as recited in claim 6 wherein securely storing a DRM license received from a license server further comprises:
transmitting a license request from the installed DRM module to a license server.

8. A method as recited in claim 1 further comprising:
browsing and selecting content for streaming from a content provider.

9. A method as recited in claim 1 wherein the content purchase receipt is in an initialization segment having a ‘pssh’ box in ‘moov’ header of an MP4 file.

10. A method as recited in claim 1 further comprising:
verifying the content purchase receipt.

11. A method as recited in claim 1 further comprising:
checking if the DRM module is already on the media playing device.

12. A method as recited in claim 1 further comprising:
receiving a license from the license server using a DRM-specific authentication protocol.

13. A method as recited in claim 1 wherein the DRM module request has a user Acct ID, a content ID and a DRM system ID.

14. A method as recited in claim 1 wherein receiving the DRM module further comprises receiving a DRM policy.

15. A method as recited in claim 1 wherein installing the DRM module in a secure virtual machine further comprises:
checking a software stack that is running the DRM module to ensure the software stack is valid.

16. A method as recited in claim 1 wherein responding to a license integrity check by the license server is done to ensure the license request is from a valid DRM module.

17. A method as recited in claim 1 wherein responding to an integrity check by the license server of the license further comprises:
receiving a request to send the license server an integrity check of the downloaded licenses.

18. A method as recited in claim 1 further comprising:
checking the hash of the stored licenses against a runtime stored hash value in a register.

19. A method of providing a DRM module to a media player device, the method comprising:
receiving a DRM download request from the media player device;
authenticating the media player device by checking whether a device certificate is valid and signed by a third party and a content provider;
performing remote static attestation of a content purchase application on the media player device; and
transmitting the DRM module to the media player device.

20. A method as recited in claim 19 wherein the DRM download request comes from a content purchase application on the media player device.

21. A method as recited in claim 19 wherein authenticating the media player device further comprises authenticating the content purchase application.

22. A method as recited in claim 19 wherein the third party is an impartial trust management entity that is trusted by a plurality of DRM vendors.

23. A method as recited in claim 19 wherein transmitting a DRM module further comprises:
transmitting a DRM policy.

24. A method as recited in claim 19 further comprising:
ensuring that a user of the media player device has a valid account ID and has paid for the content by sending a query to a content purchase token database.

25. A method as recited in claim 19 wherein the content provider performs a run-time attestation of the DRM module, said run-time attestation including transmitting a DRM security policy module to the media player device, said security policy module implemented using an interpreter that enforces proper run-time behavior of the DRM module.

26. A method as recited in claim 25 wherein said enforcing of proper run-time behavior is performed by trapping actions of a DRM agent in the DRM module as the DRM module executes on the media player device.

27. A method as recited in claim 19 further comprising:
sandboxing to monitor improper behavior of DRM agent.

28. A media player device comprising:
a media player decoder;
a processor;
a network interface;
a memory storing a content purchase application and a secure virtual machine; and
a trusted interface between the CPA and the secure VM, wherein the CPA, secure VM, and the trusted interface form a secure trusted platform.
